(19) United States
(12) Patent Application Publication
(10) Pub. No.: US 2018/0183806 A1
(43) Pub. Date: Jun. 28, 2018

(54) GUEST ACCESS PROVISIONING

(71) Applicant: Hewlett Packard Enterprise Development LP, Houston, TX (US)

(72) Inventors: Gopakumar Nambisan, Bangalore (IN); Vigneshwara Upadhyaya, Bangalore (IN); Vinay Kammar, Bangalore (IN); Vikram Limaye, North Sydney (AU)

(21) Appl. No.: 15/759,276

(22) PCT Filed: Sep. 9, 2016
(86) PCT No.: PCT/US2016/050877

§ 371 Date: Mar. 12, 2018

(30) Foreign Application Priority Data
Sep. 10, 2015 (IN) 4820/CHE/2015

(51) Int. Cl. H04L 29/06

(52) U.S. Cl. CPC H04L 63/104; H04L 63/107; H04L 63/08; H04L 63/126; H04L 63/20; H04L 63/108

(57) ABSTRACT

Example implementations may relate to a policy management system that may receive, from a scheduling application, a request to provision access for a guest. The policy management system may transmit a provisioning tool to the scheduling application, and the provisioning tool may be included in an electronic scheduling message. In response to execution of the provisioning tool, the policy management system may transmit configuration data to the device of the guest.

### BACKGROUND

An organizer or host of an event may utilize a calendar application to arrange particulars of the event, such as a date and time, a location, and invitees. The calendar application also may integrate with a web conference application. The calendar application may send to each of the invitees an electronic invitation that includes details of the event, and in some instances, details for accessing a web conference.

### BRIEF DESCRIPTION OF THE DRAWINGS

Various examples will be described below with reference to the following figures.

FIG. 1 is a block diagram that depicts an example policy management system to transmit a provisioning tool to be included in an electronic scheduling message, according to an implementation.

FIG. 2 is a flowchart of an example method for generating a guest scheduling message that includes a provisioning tool, according to an implementation.

FIG. 3A is an example interface of a scheduling application that displays guest access provisioning options.

FIG. 3B is an example interface of a scheduling application that displays guest access provisioning options.

FIG. 4 is a flowchart of an example method for sending a guest scheduling message that includes a provisioning tool, according to an implementation.

FIG. 5 is a block diagram of an example policy manager that includes a non-transitory, machine readable medium encoded with instructions to transmit a provisioning tool to be included in an electronic scheduling message, according to an implementation.

Throughout the drawings, identical reference numbers may designate similar, but not necessarily identical, elements.

### DETAILED DESCRIPTION

An organizer may utilize a scheduling application or system, such as a calendar application (e.g., Microsoft Outlook®, IBM Notes®, Google Calendar™, etc.) or a reservation or booking system to set up an event or a meeting. A scheduling application may send invitees of the meeting or event an electronic scheduling message (i.e., an invitation) via electronic mail (e-mail). In some instances, a scheduling application also may integrate with a web conference application, and the electronic scheduling message may include details for accessing the web conference application. Inclusion of web conferencing details may be useful for invitees that cannot attend the event or meeting in person.

In some cases, some invitees of the meeting or event may belong to the organization hosting the event or meeting, while other invitees may be from outside of the organization. For example, those external invitees may be vendors, clients, consultants, visitors, non-employees, etc. (collectively referred to as guests). Some organizations may control or restrict access to their physical spaces (e.g., by security checkpoints or electronically controlled doors) and to their network. Guests may have to register with a security desk or receptionist before entering the organization, and also may have to onboard electronic devices before connecting to the network. Onboarding may include configuring network settings, security settings, and other settings on the guest's devices. In some instances, onboarding may be performed by an information technology (IT) department or an automated onboarding system. Such registration or onboarding processes may be cumbersome and may add preparation time or delay the meeting or event.

Accordingly, integrating network access provisioning for guest devices into the scheduling application or system may be useful for streamlining meeting or event attendance for external guests. The term provisioning may refer to preparation of a network or a device for electronic communication between the network and the device. For example, provisioning may prepare a network and/or device, such that the device may access, via the network, a local area network (LAN), a private or public cloud, the Internet, network-enabled printers, network-enabled media devices (e.g., televisions, set top boxes, etc.), networked computers, etc.

The systems and techniques of the present application may, in some example implementations, receive a request to provision network access for a guest from a scheduling application. The request may be verified against network access policies, and a provisioning tool may be transmitted to the scheduling application. The provisioning tool may be included in an electronic scheduling message addressed to the guest and sent by the scheduling application. In response to execution of the provisioning tool from a device of the guest, configuration data may be transmitted to that device. Accordingly, the systems and techniques of the present application may be useful for integrating a system for provisioning network access for a guest device with a scheduling application, among other things.

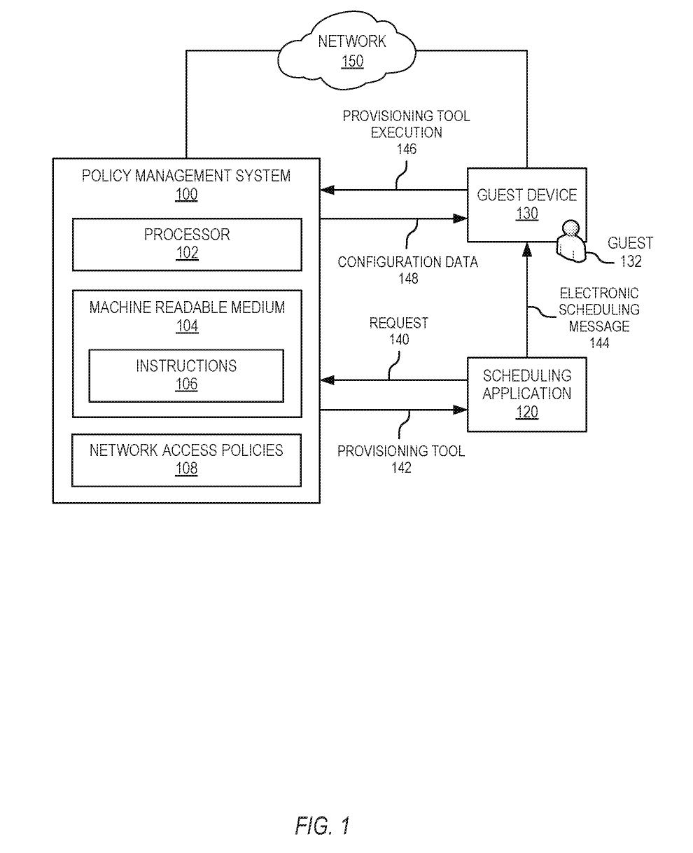

Referring now to the figures, FIG. 1 is a block diagram of an example policy management system 100 (also referred to herein as the system 100) that may transmit a provisioning tool to a scheduling application, according to an example implementation. In some implementations, the system 100 may serve as or form part of a network access policy manager that governs or manages what, when, and how electronic devices connect to and operate on a network 150, which may include wired, wireless, or virtual private network infrastructure. In some implementations, the system 100 may be implemented on a server, a network appliance, a cloud-based platform, or other computing devices or platforms. In some examples, the system 100 may be implemented by an organization, such as a business or corporation, a school, a government or government agency, a retail or service establishment (e.g., stores, hotels, venues, etc.), a club, or the like, to manage electronic devices of users of the organization's network 150. Such electronic devices may include a desktop computer, a laptop computer, a workstation, a server, a mobile device (including a smartphone), a tablet computing device, a wearable electronic device, an electronic book reader, or the like.

Some users of the organization's network 150 may be employees or other similarly affiliated persons, and the organization may configure electronic devices of those users with continual or native access to the network 150 (e.g., an employer-issued laptop or desktop). Some other users, such as a contractor, a vendor, a visitor, an invitee, a client, or other non-employees (referred to generally herein as a guest 132), may bring their own electronic device(s) (i.e., a guest device 130) when visiting or working on-site at the organization. Furthermore, a guest 132 also may refer to an employee that is visiting a site or location of their employer other than the employee's usual or home location, and the employee thus may not have native access to the network 150 at the visited site or location. In some cases, a guest 132 may be invited to the organization for a meeting or event, and an organizer (which may be an employee or agent of the organization) may coordinate various aspects related to bringing the guest 132 to the organization. For such a guest 132, the system 100 may be useful for provisioning network access for the guest device 130, as will be described below.

To support the network 150, the system 100 may include or integrate various information technology (IT) functions such as bring-your-own-device (BYOD) provisioning, firewalls, mobile device management (MDM), enterprise mobility management (EMM), security information and event management (SIEM), application access, or the like. Policies and configurations used by the system 100 to manage network access, such as policies and configurations of the aforementioned IT functions for example, may be stored as network access policies 108 in a memory or a storage on or accessible by the system 100. The network access policies 108 may be configured by, for example, an administrator of the network 150.

The system 100 may include a processor 102 and a machine readable medium 104. The processor 102 may be, for example, a microcontroller, a microprocessor, central processing unit core(s), an application-specific integrated circuit, a field programmable gate array, and/or other hardware device suitable for retrieval and/or execution of the instructions encoded or stored on the machine readable medium 104. In some implementations, the system 100 may include a plurality of processors.

For example, the machine readable medium 104 may be a random access memory (RAM), electrically erasable programmable read-only memory (EEPROM), flash memory, hard disk drives, optical discs, or the like. The machine readable medium 104 may be encoded with instructions 106. In other words, instructions 106 may be stored on the machine readable medium 104. The instructions 106, when executed by the processor 102, may cause the system 100 to perform the functionality described herein. For example, the instructions 106 may be implemented as executable code in the form of an executable application, an application programming interface (API), a subroutine, a function, a procedure, an object method/implementation, an applet, a servlet, a routine, source code, object code, a shared library/dynamic load library, or the like. Additionally or alternatively, the functionality of the system 100 described herein may be implemented as hardware devices such as logic circuits, electronic circuitry, or the like.

As described above, an organizer may invite a guest 132 on-site to an organization for an event or a meeting. For example, the organizer may invite the guest 132 utilizing a scheduling application 120, which may include or form part of a calendar application, a reservation or booking application, or the like. Accordingly, the organizer may also be referred to as a scheduling-user, that is, a user of the scheduling application 120. The scheduling application 120 may provide options to the organizer for selecting a meeting time, reserving a room or location, selecting recipients (invitees), among other scheduling options. The scheduling application 120 may also send to each recipient, including the guest 132, an electronic scheduling message such as a calendar invitation via e-mail and may manage or track responses from the recipients. The scheduling application 120 may be implemented on a computing device operated by the organizer, such as a desktop computer, a laptop computer, a server, a tablet computer, a mobile device (e.g., smartphone), or the like. In some implementations, the scheduling application 120 may be implemented on a cloud-based platform which in turn is accessed by a computing device. For example, the scheduling application 120 may be implemented as executable code in the form of an executable application, an API, a subroutine, a function, a procedure, an object method/implementation, an applet, a servlet, a routine, source code, object code, a shared library/dynamic load library, or the like.

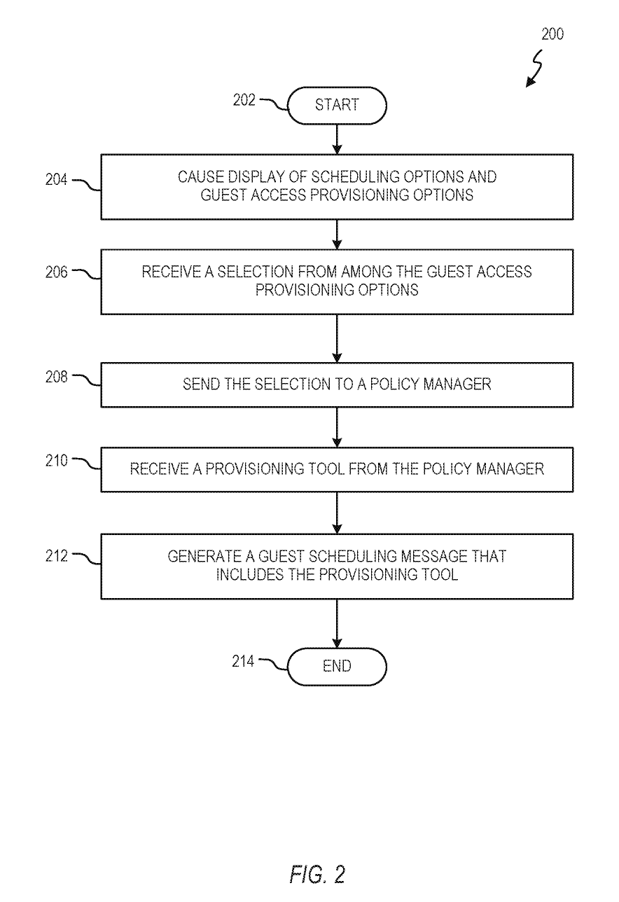

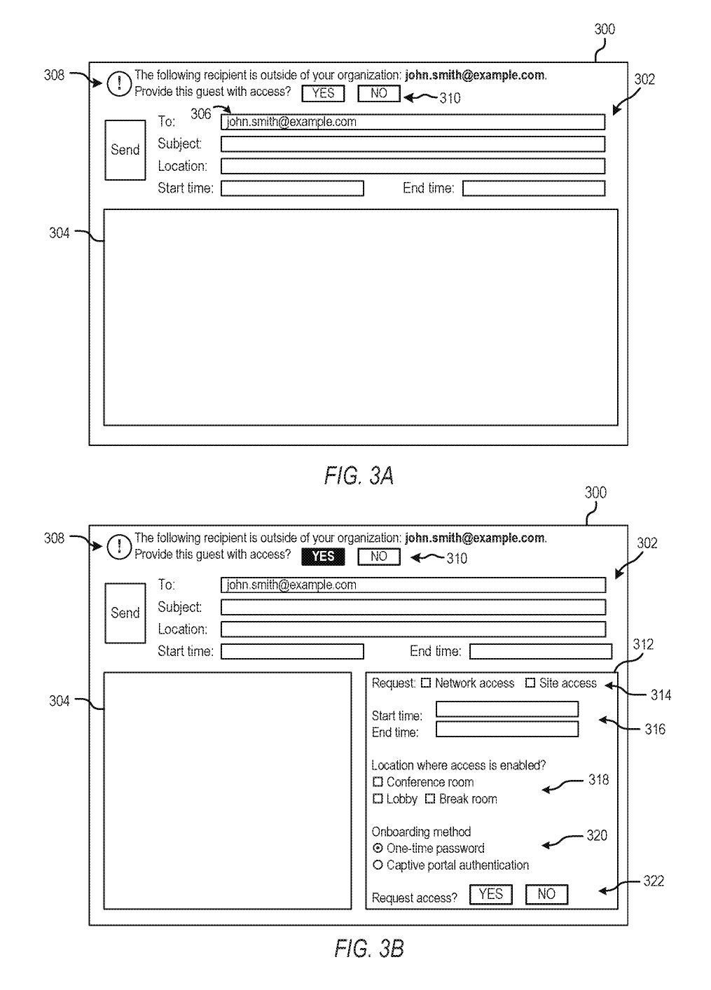

As will be described in greater detail below with respect to FIGS. 2, 3A, and 3B, the organizer may also utilize the scheduling application 120 to provision access for the guest 132, and in particular, access for the guest device 130 to the network 150. To that end, the scheduling application 120 may provide guest access provisioning options to be selected or configured by the organizer. In some implementations, the scheduling application 120 and the system 100 (via execution of the instructions 106 by the processor 102) may each provide API function calls, by which the scheduling application 120 and the system 100 exchange requests and data.

From the perspective of system 100 (with processor 102 executing the instructions 106), the system 100 may receive, from the scheduling application 120, a request 140 to provision network access for the guest 132 and guest device 130. In some implementations, the request 140 may be a function call and may specify parameters related to network access to be provisioned for the guest 132. The parameters included in the request 140 may be selected by the organizer via the scheduling application 120. For example, the request 140 may identify the guest 132 (e.g., a name, an e-mail address, a phone number, etc.) and may include an access time period (i.e., a time period when the guest device 130 is permitted to access the network 150, as defined by, e.g., a date, a start time, an end time, etc.), an access location (i.e., a physical area or logical area related to access points of the network 150, where the guest device 130 is permitted to access the network 150), and an onboarding method (e.g., one-time password, captive portal authentication). The parameters also may specify a type of access to provision for the guest 132. In some implementations, the parameters may specify a request for network access or a request for physical site access (e.g., access through electronically controlled or badge access security doors and areas).

The system 100 may verify the request 140 against the network access policies 108. For example, the system 100 may verify whether the organizer using the scheduling application 120 is authorized to request provisioning of access for the guest 130 (e.g., based on a list of authorized requestors in the network access policies 108). In some examples, the system 100 may verify whether a combination of parameters included in the request 140 is permitted according to the network access policies 108. For example, the network access policies 108 may specify that certain access locations are not permitted during certain access time periods, because of, by illustration only, secret or confidential activities (e.g., research and development activities, merger and acquisition activities, etc.). In some implementations, the system 100 may deny a request 140 that violates the network access policies 108 and accordingly may send an error message to the scheduling application 120.

On the other hand, if the request 140 does not violate any of the network access policies 108, the system 100 may process the request 140 by, for example, creating a profile associated with the guest 132 (e.g., the profile may be stored in memory or in storage of the system 100, and/or in network access policies 108) that will permit the guest 132 to use the guest device 130 on the network 150 within the parameters of the request 140 (e.g., within the specified time and locations, etc.). When processing the request 140, the system 100 also may generate a provisioning tool 142 by which the guest 132 will connect the guest device 130 to the network 150 in a manner described below (also referred to as a process of onboarding the guest device 130). For example, the provisioning tool 142 may be a hyperlink (e.g., a Uniform Resource Locator, or a button representation thereof), that can be opened or executed on the guest device 130, where the hyperlink refers to a web server hosted by the system 100. In other examples, the provisioning tool 142 may be a set of instructions to be executed (that is, implemented or followed) by the guest 132 to onboard the guest device 130 (e.g., instructions to connect the guest device 130 to a particular Service Set Identifier, abbreviated as SSID, broadcast by the network 150 that leads to a captive portal).

The system 100 may transmit the provisioning tool 142 to the scheduling application 120. In some implementations, the provisioning tool 142 is to be included by the scheduling application 120 in an electronic scheduling message 144 addressed to the guest 132, and the guest 132 may receive or access the electronic scheduling message 144 on the guest device 130. For example, as described above, the electronic scheduling message 144 may be a calendar invitation, and the provisioning tool 142 may be included in the body of the calendar invitation (e.g., in the case that the provisioning tool 142 is a hyperlink or a set of instructions for the guest 132).

At some point in time, such as prior to or at the time of guest 132 arrival for the event or meeting, the guest 132 may execute or activate the provisioning tool from the guest device 130 (depicted as execution 146). In some implementations, instructions 106 may include instructions to host a web server to assist with onboarding.

For example, in some implementations, the provisioning tool 142 may include a hyperlink, as described above, that refers to the web server hosted by the system 100, and execution 146 of the provisioning tool may include an HTTP GET request. By executing or opening the hyperlink on the guest device 130, the guest device 130 may be directed to a web page hosted by the web server, and the guest 132 may download an installation package or executable file containing the configuration data 148. Alternatively or additionally, executing or opening the hyperlink on the guest device 130 may cause the web server to push the configuration data 148 to the guest device 130. In some implementations, the web server may authenticate the guest, for example, using a one-time password sent to the guest by e-mail, short message service, etc., if a one-time password onboarding method was specified in the request as described above.

In some implementations, as described above, the provisioning tool 142 may include step-by-step instructions for the guest 132 to connect the guest device 130 to a particular SSID. The SSID may direct the guest device 130 to a captive portal for onboarding (e.g., a captive portal hosted by the web server of system 100). At the captive portal, the guest 132 may be requested to identify themselves (e.g., using an e-mail address or a passcode provided with the provisioning tool 142), and upon successful identification, the captive portal may push configuration data 148 to the guest device 130 or may present configuration data 148 to be downloaded by the guest 132 (e.g., via a web page).

In response to execution 146 of the provisioning tool from (or on) the guest device 130, the system 100 may transmit configuration data 148 to the guest device 130. In some implementations, the system 100 may push configuration data 148 to the guest device 130. The configuration data 148 may automatically (or semi-automatically, with prompts to the guest 132) set up the guest device 130 to access the network 150. For example, the configuration data 148 may include network authentication credentials (e.g., certificates) or network settings (e.g., an SSID name, an encryption type, a pre-shared key for encryption, enabling 802.1x authentication, other wireless networking settings, etc.). In some implementations, the configuration data 148 may audit and clear existing credentials on the guest device 130.

In some implementations, the configuration data 148 may include physical site access credentials for use with near-field communications (NFC) of the guest device 130. For example, such physical site access credentials may be loaded into a programmable NFC subsystem of the guest device 130, such that the guest 132 may use the guest device 130 to enter electronically controlled doors or areas (e.g., via NFC access).

In some implementations, the provisioning tool 142 may include a selectable option for each of different operating systems (e.g., Microsoft® Windows®, Apple® OS X®, Apple® iOS, Android™, etc.). For example, the selectable options may include a first hyperlink for a first operating system, a second hyperlink for a second operating system, and so on. The guest 132 may select an option of the provisioning tool 142 and execute that selected option from the guest device 130. In response to execution of the selected option, the system 100 may transmit configuration data 148 that is compatible with the operating system corresponding to the selected option. Including selectable options in this manner may be useful for addressing the diversity of devices or operating systems that different guests may bring on-site to the organization, and the corresponding diversity of mechanisms and components (e.g., APIs, drivers, etc.) related to configuring networking settings and accessing the network 150 on each of those devices or operating systems. For example, in some instances, the Android operating system may utilize a QuickConnect API for onboarding while the Apple iOS operating system may utilize an Over-the-Air API.

In some implementations, once the guest device 130 is onboarded to (configured for) the network 150, the system 100 may monitor activity of the guest device 130 to verify whether the guest device 130 is operating within the parameters dictated in the guest access provisioning request 140 or other policies (e.g., network access policies 108). If the guest device 130 violates the network access policies 108 or the parameters set forth in the request 140, the system 100 may disconnect the guest device 130 from the network 150 and may prohibit further access by the guest device 130 (e.g., by filtering the media access control address, or MAC address, of the guest device 130).

In some implementations, the system 100 also may respond to scheduling changes effected by the scheduling application 120. In particular, instructions 106 may include instructions that (when executed by the processor 102) modify or invalidate the configuration data 148 in response to a scheduling change at the scheduling application 120. Additionally or alternatively, the system 100 may execute instructions that modify the guest-related profile created in response to the request 140 (e.g., a profile that may be stored with network access policies 108) to update the time and location within which the guest 132 is permitted to access the network 150 (or permitted to access the site via electronic security doors) using the guest device 130. In some implementations, modified configuration data 148 may be pushed down to the guest device 130 if the guest 132 had previously executed the provisioning tool (e.g., 146). On the other hand, if the guest did not execute the provisioning tool prior to the scheduling change, execution 146 of the provisioning tool in a first instance will cause the system 100 to transmit the modified configuration data 148. Such changes to the configuration data 148 and/or the profile may be useful for aligning guest access to a modified meeting or event schedule. For example, the organizer may change a time or location of the event or meeting at the scheduling application 120, or also may change parameters of the access previously provisioned for the guest 132.

FIG. 2 is a flowchart of an example method 200 for generating a guest scheduling message that includes a provisioning tool, according to an implementation. Method 200 may be implemented in the form of executable instructions stored on a machine readable storage medium and executed by at least one processor of a computing device or cloud computing platform, and/or in the form of electronic circuitry. Method 200 may be described below as being executed or performed by a scheduling system, which may include or form part of the scheduling application 120 described above in connection with FIG. 1. For example, the scheduling system described herein may be a computing device (e.g., a desktop computer, a laptop computer, a server, a tablet computer, a mobile device, etc.) or cloud computing platform performing executable instructions that comprise the scheduling application 120. In some implementations, an organizer may use the scheduling system, operating in accordance to the method 200, to provision access for a guest (e.g., 132) to use a guest device (e.g., 130) on a network (e.g., 150).

In some implementations of the present disclosure, one or more blocks of method 200 may be executed substantially concurrently or in a different order than shown in FIG. 2. In some implementations of the present disclosure, method 200 may include more or less blocks than are shown in FIG. 2. In some implementations, one or more of the blocks of method 200 may, at certain times, be ongoing and/or may repeat.

The method 200 may begin at block 202, and continue to block 204, where a scheduling system may cause display (e.g., on a screen, a monitor, etc. connected to or in communication with the scheduling system) of scheduling options and guest access provisioning options. Examples of the scheduling options and guest access provisioning options will be discussed further herein below with respect to FIGS. 3A and 3B. In some implementations, block 204 may cause display of scheduling options and guest network access provisioning options on a same user interface (e.g., in a same user interface window). In some examples, the guest network access provisioning options displayed at block 204 may include an access time period, an access location, an onboarding method, a request for network access, or a request for physical site access.

At block 206, the scheduling system may receive, from a scheduling-user (i.e., a user of the scheduling system), a selection from among the guest access provisioning options. The scheduling-user may be an organizer of an event or meeting to which a guest (e.g., 132) is being invited. For example, the scheduling-user may use a pointing device, a keyboard, a touchscreen, etc. to select from among the guest access provisioning options.

At block 208, the scheduling system may send the selection received at block 206 to a policy manager. For example, the policy manager may be analogous to the system 100 in many respects, and the selection sent by the scheduling system at block 208 may be or form part of the request 140, such as the parameters included in the request 140 related to access to be provisioned for the guest 132 as described above.

At block 210, the scheduling system may receive a provisioning tool from the policy manager. In some implementations, the provisioning tool may be analogous in many respects to the provisioning tool 142 described above. For example, the provisioning tool received at block 210 may include a hyperlink that refers to the policy manager, or more particularly, to a web server or web page hosted by the policy manager. In some implementations, the provisioning tool, once received by the scheduling system, may be hidden from the scheduling-user. In other words, the provisioning tool may be inaccessible to the scheduling-user, by virtue of the provisioning tool being securely stored at the scheduling system and/or not displayed by the scheduling system.

At block 212, the scheduling system may generate a guest scheduling message based on scheduling-user selected ones of the scheduling options and including the provisioning tool. In some implementations, the guest scheduling message may be analogous in many respects to the electronic scheduling message 144 described above. For example, the guest scheduling message may be an electronic calendar invitation.

The provisioning tool included in the guest scheduling message may, when executed (e.g., 146) from a guest device (e.g., 130), request the policy manager (e.g., 100) to push configuration data (e.g., 148) to the guest device. The configuration data may enable the guest device to connect to a network (e.g., 150) in accordance with the selection of guest access provisioning options received from the scheduling-user (e.g., at block 206). The method 200 may end at block 214.

FIGS. 3A and 3B are examples of an interface 300 of a scheduling application (e.g., 120) or a scheduling system (e.g., as described above with respect to FIG. 2). An organizer may interact with the interface 300 by way of a pointing device (e.g., a mouse, a touchpad, a stylus, etc.), a keyboard, a touchscreen, etc., to schedule a meeting or event. In some implementations, the interface 300 may be included in a user interface window.

FIG. 3A depicts example scheduling options 302, which may include an addressee field (labeled “To:”), a subject field, a location field, a start time field, and an end time field. FIG. 3A also depicts a message field 304, where an organizer may include a message or attachments. In some implementations, the scheduling application or system may be communicate with a directory of an organization (e.g., a lightweight directory access protocol, or LDAP, server), and upon entry by the organizer of a recipient in the addressee field (e.g., a recipient name, a recipient e-mail address, etc.), the scheduling application or system may search the organization's directory for the recipient to determine if the recipient is inside or outside the organization. In some implementations, if the recipient is included in the directory, the scheduling application or system may further search the directory to determine if the recipient is located at or has access to the location of the meeting or event. If the recipient is not included in the directory or is not located at (or does not have access to) the location of the meeting or event, the scheduling application or system may cause the interface 300 to display a prompt 308 that notifies the organizer that the recipient is outside of the organization (or outside of the location). In some implementations, the prompt 308 may provide an option to provision access for that recipient (e.g., “YES” and “NO” buttons), and if the organizer selects “YES”, the scheduling application or system may cause the interface 300 to further display guest access provisioning options, as will now be described with respect to FIG. 3B.

FIG. 3B depicts the interface 300 displaying example guest access provisioning options in a segment 312. For example, the guest access provisioning options may include options 314 to request network access and/or site access (e.g., NFC-based door or area access, etc.), an access time period option 316 (e.g., including start and end times), an access location option 318 (e.g., check boxes for different locations), and an onboarding method option 320 (e.g., radio buttons for different onboarding methods, such as one-time password, captive portal authentication, etc.). The organizer may click “YES” at an access request segment 322, and in response, the scheduling application or system may transmit (e.g., by executing block 208) a provisioning request (e.g., which may be analogous to the request 140) to a policy manager (e.g., which may be analogous to the system 100).

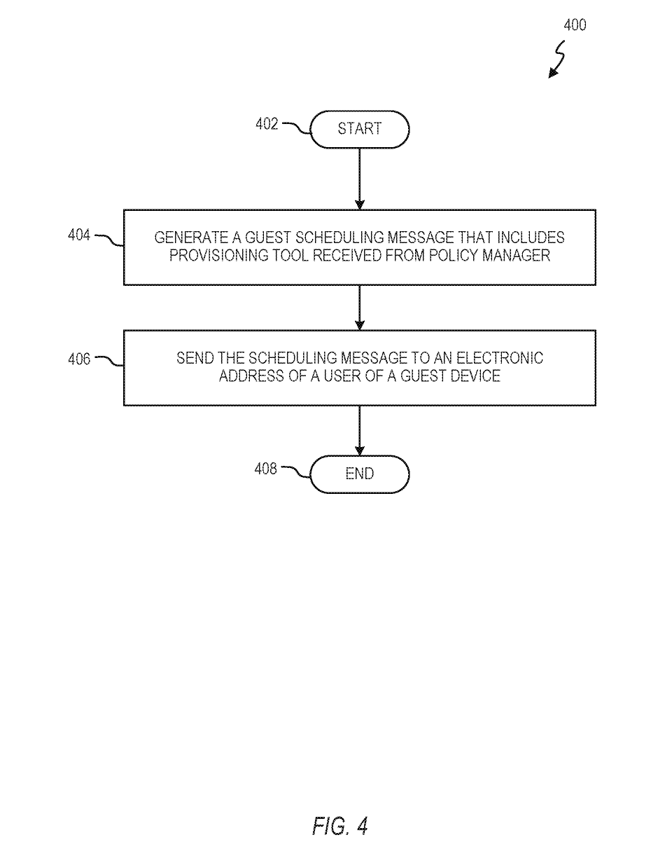

FIG. 4 is a flowchart of an example method 400 for sending a guest scheduling message that includes a provisioning tool, according to an implementation. Method 400 may be implemented in the form of executable instructions stored on a machine readable storage medium and executed by at least one processor, and/or may be implemented in the form of electronic circuitry. As with method 200, method 400 may be described below as being executed or performed by a scheduling system, which may include or form part of the scheduling application 120. In some implementations of the present disclosure, one or more blocks of method 400 may be executed substantially concurrently or in a different order than shown in FIG. 4. In some implementations of the present disclosure, method 400 may include more or less blocks than are shown in FIG. 4. In some implementations, one or more of the blocks of method 400 may, at certain times, be ongoing and/or may repeat. In some implementations, the method 400 may be performed in conjunction with the method 200.

The method 400 may begin at block 402, and continue to block 404, where the scheduling system may generate a guest scheduling message that includes a provisioning tool received from a policy manager. Block 404 may be analogous in many respects to block 212 described above.

At block 406, the scheduling system may send the guest scheduling message (e.g., generated at block 404) to an electronic address of a user (e.g., 132) of the guest device (e.g., 130). For example, the guest scheduling message may be a calendar invitation. In some implementations, the provisioning tool included in the guest scheduling message is visible only to the guest for which the provisioning tool was requested. Other recipients of guest scheduling messages related to the same event or meeting may not see the provisioning tool. At block 408, the method 400 may end.

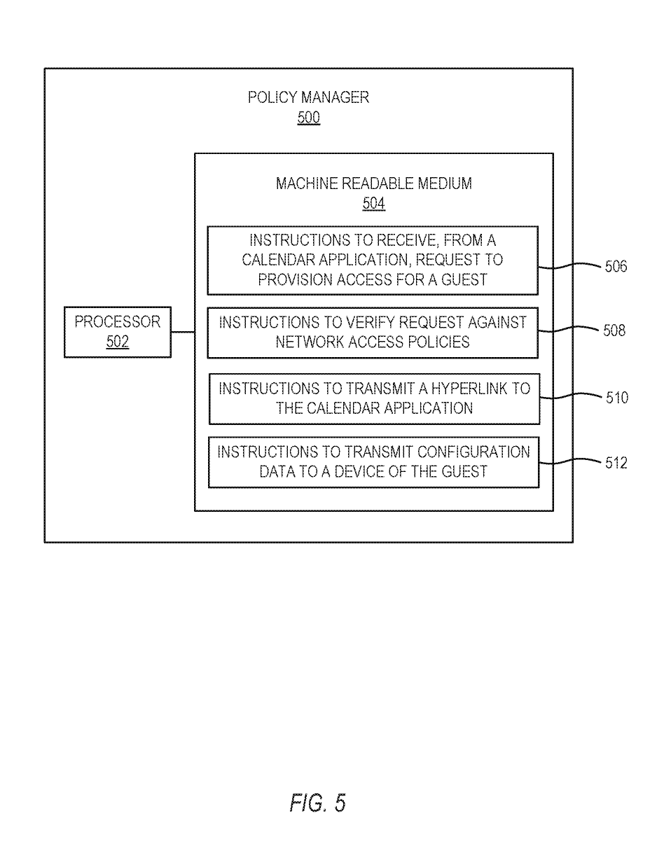

FIG. 5 is a block diagram illustrating a policy manager 500 that includes a machine readable medium encoded with example instructions to transmit a provisioning tool to be included in an electronic scheduling message. In some implementations, the policy manager 500 may serve as or form part of the policy management system 100 in FIG. 1 or the policy manager described above with respect to FIG. 2. In some implementations, the policy manager 500 may include at least one processor 502 coupled to a machine readable medium 504.

The processor 502 may include a single-core processor, a multi-core processor, an application-specific integrated circuit, a field programmable gate array, and/or other hardware device suitable for retrieval and/or execution of instructions from the machine readable medium 504 (e.g., instructions 506, 508, 510, 512, 514) to perform functions related to various examples. Additionally or alternatively, the processor 502 may include electronic circuitry for performing the functionality described herein, including, but not limited to, the functionality of instructions 506, 508, 510, and/or 512. With respect to the executable instructions represented as boxes in FIG. 5, it should be understood that part or all of the executable instructions and/or electronic circuits included within one box may, in alternate implementations, be included in a different box shown in the figures or in a different box not shown.

The machine readable medium 504 may be any medium suitable for storing executable instructions, such as random access memory (RAM), electrically erasable programmable read-only memory (EEPROM), flash memory, hard disk drives, optical discs, or the like. In some example implementations, the machine readable medium 504 may be a tangible, non-transitory medium, where the term “non-transitory” does not encompass transitory propagating signals. The machine readable medium 504 may be disposed within the policy manager 500, as shown in FIG. 5, in which case the executable instructions may be deemed “installed” or “embedded” on the policy manager 500. Alternatively, the machine readable medium 504 may be a portable (e.g., external) storage medium, for example, that allows the policy manager 500 to remotely execute the instructions or download the instructions from the storage medium. In this case, the executable instructions may be part of an “installation package.” As described further herein below, the machine readable medium 504 may be encoded with a set of executable instructions 506, 508, 510, 512, 514. In some implementations, instructions 506, 508, 510, 512 may serve as or form part of instructions 106 of FIG. 1.

Instructions 506, when executed by the processor 502, may receive, from a calendar application (or more generally, a scheduling application or scheduling system), a request to provision access for a guest. In some implementations, the request may specify parameters related to the access to be provisioned for the guest, including an identity or identifier of the guest, an access time period, an access location, an onboarding method, a request for network access, or a request for physical site access. In some implementations, the request may include an identity of a user of the calendar application, such as an e-mail address, a user name, or the like. For example, the user of the calendar application may be an organizer of an event or meeting to which the guest is invited.

Instructions 508, when executed by the processor 502, may verify the request against network access policies. In some implementations, instructions 508 may verify whether the user of the calendar application is authorized to request provisioning of access for the guest.

Instructions 510, when executed by the processor 502, may transmit a hyperlink (or more generally, a provisioning tool) to the calendar application. The hyperlink may be intended for inclusion in an electronic calendar invitation addressed to the guest by, for example, e-mail.

Instructions 512, when executed by the processor 502, may transmit configuration data to a device of the guest, in response to opening or activation of the hyperlink from the guest's device. In some implementations, the configuration data includes network authentication credentials, network settings, or physical site access credentials for use with near-field communications of the guest's device.

In view of the foregoing description, it can be appreciated that a scheduling system and a policy manager may be integrated to streamline provisioning of guest access, such as guest access to a network at a meeting site. By virtue of including guest access provisioning options together with scheduling options in a scheduling system, such as in a user interface of the scheduling system, an organizer may schedule an event and concurrently provision access for a guest without using separate and disparate applications. Moreover, by virtue of including a provisioning tool in an electronic scheduling message sent to the guest, event details and guest device onboarding details may be conveniently co-located for the guest, such as in a same event on the guest's calendar. Accordingly, guest access to a network may be provisioned and a guest device may be onboarded without intervention by IT personnel.

In the foregoing description, numerous details are set forth to provide an understanding of the subject matter disclosed herein. However, implementation may be practiced without some or all of these details. Other implementations may include modifications and variations from the details discussed above. It is intended that the following claims cover such modifications and variations.

We claim:

1. A policy management system comprising:
a processor; and
a machine readable medium encoded with instructions that, when executed by the processor:
receive, from a scheduling application, a request to provision network access for a guest;
verify the request against network access policies,
transmit, to the scheduling application, a provisioning tool to be included in an electronic scheduling message addressed to the guest, and
transmit configuration data to a device of the guest, in response to execution of the provisioning tool from the device.

2. The policy management system of claim 1, wherein the request specifies parameters related to the network access, including an access time period, an access location, an onboarding method, a request for network access, or a request for physical site access.

3. The policy management system of claim 1, wherein the configuration data includes network authentication credentials or network settings.

4. The policy management system of claim 1, wherein the configuration data includes physical site access credentials for use with near-field communications of the device.

5. The policy management system of claim 1, wherein the machine readable medium further includes instructions that, when executed by the processor, modify or invalidate the configuration data in response to a scheduling change at the scheduling application.

6. The policy management system of claim 1, wherein the machine readable medium further includes instructions to host a web server, and the provisioning tool includes a hyperlink that refers to the web server.

7. The policy management system of claim 1, wherein the provisioning tool includes a selectable option for each of different operating systems, and
for execution of a selected option, the transmitted configuration data is compatible with an operating system corresponding to the selected option.

8. The policy management system of claim 1, wherein the scheduling application is a calendar application, and the electronic scheduling message is a calendar invitation.

9. A method comprising:
causing display, by a scheduling system, of scheduling options and guest access provisioning options;
receiving, at the scheduling system from a scheduling-user, a selection from among the guest access provisioning options;
sending, by the scheduling system, the selection to a policy manager;
receiving, by the scheduling system, a provisioning tool from the policy manager; and
generating, by the scheduling system, a guest scheduling message based on scheduling-user selected ones of the scheduling options and including the provisioning tool,
wherein the provisioning tool, when executed from a guest device, requests the policy manager to push configuration data to the guest device, the configuration data to enable the device to connect to a network in accordance with the selection.

10. The method of claim 9, wherein the causing causes display of scheduling options and guest network access provisioning options on a same user interface.

11. The method of claim 9, wherein the guest network access provisioning options include an access time period, an access location, an onboarding method, a request for network access, or a request for physical site access.

12. The method of claim 9, further comprising sending, by the scheduling system, the guest scheduling message to an electronic address of a user of the guest device, wherein
the guest scheduling message is an electronic calendar invitation,
the provisioning tool includes a hyperlink that refers to the policy manager, and
the provisioning tool is hidden from the scheduling-user.

13. A non-transitory machine readable medium, storing instructions executable by a processor of a policy manager, the non-transitory machine readable medium comprising:
instructions to receive, from a calendar application, a request to provision access for a guest;
instructions to verify the request against network access policies;
instructions to transmit a hyperlink to the calendar application, the hyperlink to be included in an electronic calendar invitation addressed to the guest, and
instructions to transmit configuration data to a device of the guest, in response to opening of the hyperlink from the device.

14. The non-transitory machine readable medium of claim 13, wherein the request includes an identity of a user of the calendar application, and the instructions to verify whether the user is authorized to request provisioning of access for the guest.

15. The non-transitory machine readable medium of claim 13, wherein the request specifies parameters related to the access to be provisioned, including an access time period, an access location, an onboarding method, a request for network access, or a request for physical site access, and
the configuration data includes network authentication credentials, network settings, or physical site access credentials for use with near-field communications of the device.
